(19) United States
(12) Patent Application Publication
(10) Pub. No.: US 2013/0218699 A1
(43) Pub. Date: Aug. 22, 2013

(54) SYSTEM AND METHOD FOR REDUCING POINT-OF-SALE TIRE INVENTORY

(71) Applicant: Scott Damon, Brentwood, TN (US)

(72) Inventor: Scott Damon, Brentwood, TN (US)

(21) Appl. No.: 13/760,100

(22) Filed: Feb. 6, 2013

Related U.S. Application Data
(60) Provisional application No. 61/595,969, filed on Feb. 7, 2012.
(60) Provisional application No. 61/595,980, filed on Feb. 7, 2012.
(60) Provisional application No. 61/595,985, filed on Feb. 7, 2012.
(60) Provisional application No. 61/595,987, filed on Feb. 7, 2012.
(60) Provisional application No. 61/595,990, filed on Feb. 7, 2012.
(60) Provisional application No. 61/595,997, filed on Feb. 7, 2012.

(51) Int. Cl. G06Q 30/06; B29D 30/08

(52) U.S. Cl. CPC G06Q 30/06; B29D 30/08; G06Q 10/087
USPC 705/22; 156/123; 156/394.1; 705/28

(57) ABSTRACT

Systems and methods are disclosed for manufacturing a tire selected having a certain performance and/or size characteristic from a range of tread-casing combinations having a range of performance and/or size characteristics from a reduced inventory supply. The systems and methods for producing tires can be used to build tires having a selected performance characteristic from an inventory supply having reduced storage time. A customized tire can be produced by providing, either at or near a point-of-sale facility, a set of cured tire casings manufactured without tire treads and a set of cured tire treads manufactured without tire casings. A tire that is customized to the customer is built upon demand at an assembly facility at or near the point-of-sale and delivered to the customer at or near the time of building upon demand by the customer.

### CROSS-REFERENCE TO RELATED APPLICATIONS

This patent application claims the benefit of priority to:
(1) U.S. Provisional Patent Application No. 61/595,969, filed on Feb. 7, 2012, and entitled “System and Method for Decentralized Manufacture of New Tires Enabling Improved Performance Characteristics”;
(2) U.S. Provisional Patent Application No. 61/595,980, filed on Feb. 7, 2012, and entitled “System and Method for Customizing Vehicle Tires on Demand at Point-of-Sale”;
(3) U.S. Provisional Patent Application No. 61/595,985, filed on Feb. 7, 2012, and entitled “System and Method for Reducing Point-of-Sale Tire Inventory”;
(4) U.S. Provisional Patent Application No. 61/595,987, filed on Feb. 7, 2012, and entitled “System and Method for Tracking Inventory of Tire Components at Point-of-Sale Facility”;
(5) U.S. Provisional Patent Application No. 61/595,990, filed on Feb. 7, 2012, and entitled “System and Method for Pricing, Leasing and Transferring Ownership of Tires”; and
(6) U.S. Provisional Patent Application No. 61/595,997 , filed on Feb. 7, 2012, and entitled “System and Method for Customizing and Manufacturing Tires Near Point-of-Sale,”
   which are incorporated in their entireties herein by this reference.

### BACKGROUND OF THE INVENTION

Tire manufacturing is a laborious and time-consuming process that is typically conducted at dedicated manufacturing facilities. Such facilities have extensive manufacturing equipment specifically configured to produce tires. A typical tire is made by assembling various materials to form an uncured green rubber tire. The tire is made of natural or synthetic rubber that is layered with other materials such as steel or fiber belts, meshes, and the like. Typical newly-manufactured tires are made in a single molding and press operation. The casing of such a tire can include an inner liner, a body ply, the sidewalls, beads, apex, belt package, and other structures. The tread of such a tire can include a thick belt that is wrapped around and molded along with the casing. The green tire is then placed in a mold and vulcanized or cured using heat and pressure. This process bonds the tire components together. The completed new tires are generally distributed from the tire manufacturing plant to original equipment manufacturer (“OEM”) vehicle manufacturers, wholesale distribution centers, tire distributors, repair shops, and other points-of-sale. The particular surface characteristics of the tire, such as the tread pattern, are imparted into the preform during the molding stages. During service, the tread portion becomes worn, thus necessitating that the tire be replaced or reconditioned.

In addition, tires are large items which require a lot of inventory space, and there is a vast number of different tire types and models. To ensure that the spectrum of tire choices that a customer may want are on hand, point-of-sale facilities are required to stock large amounts of tires, which results in a large capital investment in inventory and in the storage of the tires in inventory.

The large and varied inventory maintained by a point-of-sale facility can lead to additional costs related to the discarding of old tires. The materials used to manufacture new tires have a finite shelf life in the retail environment. As a tire ages in inventory, the tire can lose some of its performance capabilities. Furthermore, an inventory of tires kept in unfavorable environmental conditions, such as high heat and low humidity, for example, may adversely affect the quality of the tires.

As a result, a tire manufacturer or retailer may frequently sell off tire inventory at reduced prices, often at little to no profit. Products that cannot be sold at a discount are typically discarded and/or recycled. Such waste is costly and increases the cost of goods sold for manufacturers.

Thus, there has been a long-standing need to improve the manner in which new tires are manufactured and made available to customers. Furthermore, there is a continued need in the art for systems and methods for producing a tire in a manner that helps reduce the inefficiencies associated with maintaining a large inventory of tires at a point-of-sale facility.

### SUMMARY OF THE DISCLOSURE

In one embodiment, a system for manufacturing tires having a predetermined tire characteristic is described. An inventory facility is configured to maintain a casing inventory including a plurality of different types of cured casings and a tread inventory including a plurality of different types of cured treads. An assembly facility includes tire building equipment adapted to produce a new tire having the predetermined tire characteristic using a tread-casing combination. The tread-casing combination includes a selected type of the cured casings in the casing inventory and a selected type of the cured treads in the tread inventory of the inventory facility. The casing inventory and the tire inventory are configured such that, for a particular type of cured casing in the casing inventory, multiple types of cured treads in the tread inventory are compatible with the particular type of cured casing to produce different tread-casing combinations, each including the particular type of cured casing.

In another embodiment, a method of manufacturing tires having a predetermined tire characteristic is described. A casing inventory including a plurality of different types of cured casings and a tread inventory including a plurality of different types of cured treads are maintained at an inventory facility. The cured treads are separately manufactured from the cured casings. In response to receiving a tire order for a tire having a particular tire characteristic, a new tire is built using a tread-casing combination including a selected type of the cured casings in the casing inventory and a selected type of the cured treads in the tread inventory of the inventory facility. The new tire has the tire characteristic. The casing inventory and the tire inventory are configured such that, for a particular type of cured casing in the casing inventory, multiple types of cured treads in the tread inventory are compatible with the particular type of cured casing to produce different tread-casing combinations including the particular type of cured casing.

In still another embodiment, a tire component inventory control system is described. A tire inventory control program is stored on a tangible computer-readable medium. A processor is adapted to execute the tire inventory control program contained on the computer-readable medium. A data storage device is operably arranged with the processor and adapted to store therein inventory information relating to a casing inventory including a plurality of different types of cured casings and a tread inventory including a plurality of different types of cured treads maintained at an inventory facility. The cured treads are separately manufactured from the cured casings. The tire inventory control program is adapted, in response to receiving tire order information identifying a tire having a tire characteristic, to use the tire order information to determine at least one tread-casing combination including a selected type of the cured casings in the casing inventory and a selected type of the cured treads in the tread inventory of the inventory facility. Each such tread-casing combination is adapted to produce the new tire having the tire characteristic.

Further and alternative aspects and features of the disclosed principles will be appreciated from the following detailed description and the accompanying drawings. As will be appreciated, the principles related to systems and methods for customizing and manufacturing tires and tire component inventory control systems and methods disclosed herein are capable of being carried out in other and different embodiments, and capable of being modified in various respects. Accordingly, it is to be understood that the foregoing general description and the following detailed description is exemplary and explanatory only and does not restrict the scope of the disclosed principles.

### BRIEF DESCRIPTION OF THE SEVERAL VIEWS OF THE DRAWINGS

FIG. 1 is a schematic view of an embodiment of a system for the distributed manufacture of custom tires in accordance with principles of the present disclosure.

FIG. 2 is a schematic view of an embodiment of a system and method for producing customized tires that are built and installed to emphasize certain enhanced performance characteristics of the tires from a reduced inventory supply.

FIG. 3 is a schematic view of an embodiment of a system and method for producing customized tires that are built and installed to emphasize certain enhanced performance characteristics of the tires from a reduced inventory supply.

FIG. 4 is a schematic diagram of an embodiment of a computer-implemented system having a physical computer program product including computer-executable instructions for tire component inventory control.

### DETAILED DESCRIPTION OF PREFERRED EMBODIMENTS

Alternative aspects and features of the disclosed principles will be appreciated from the following detailed description and the accompanying drawings. As will be appreciated, the principles related to systems and methods for reducing point-of-sale tire inventory disclosed herein are capable of being carried out in other and different embodiments, and capable of being modified in various respects. Accordingly, it is to be understood that the following detailed description is exemplary and explanatory only and does not restrict the scope of the disclosed principles.

In an exemplary embodiment, a method is provided for producing build-your-own customized tires that are built and installed to emphasize certain enhanced performance characteristics of the tires from a reduced inventory supply. The method includes providing, either at or at a location near a point-of-sale, an inventory of a set of cured tire casings without tire treads to provide enhanced performance characteristics, such as reduced rolling resistance. Such enhancement is facilitated by separately manufacturing, through at least partial curing and vulcanization, the tire casings from the tire treads. An inventory of a set of cured tire treads manufactured without tire casings are also provided either at or at a location near a point-of-sale, a set of cured tire casings. The tire treads are manufactured to provide enhanced performance characteristics such as tire tread wear and wet resistance, which are facilitated by separately manufacturing the tire treads from the tire casings. The inventories of cured tire casings and cured treads are configured such that for a given tire casing there are multiple combinations of compatible cured treads to provide enhanced performance characteristics such as low rolling resistance, for example. The sets of casings and treads are manufactured so that they can be assembled in various combinations to generate multiple tire options at the time of a request by a customer so that an inventory of assembled tires for each possible combination need not be maintained. A new tire that is customized to the customer is built upon demand by a customer either at or near the point-of-sale by combining a selected tread from the set of treads and a selected casing form the set of casings.

In another embodiment, a method is provided for producing tires that are built and installed to emphasize certain enhanced performance characteristics of the tires from an inventory supply having reduced storage time. An inventory of different types of unassembled curd casings, each casing type having a performance and/or size characteristic, and an inventory of different types of cured treads, each tread type having a performance and/or size characteristic, are maintained at or near an assembly facility which itself is at or near a point-of-sale facility. A specific unassembled cured casing, based upon a selection of a casing type made by a customer, is supplied to the assembly facility from the inventory of said cured tire casings based on shelf times of said cured tire casings in inventory so that the unassembled cured tire casing is supplied from a group of casings that have an average age that is greater than the average age of the remainder of the inventory of said cured tire casings. A specific unassembled cured tire tread, based upon a selection of a tread type, is supplied to the assembly facility for joining with the supplied cured tire casing. The specific unassembled cured casing and the specific cured tread are combined at the assembly facility to form a new tire.

The number of different types of tire treads can be larger than the number of different types of casings. The specific new tire can be chosen from a range of tread-casing combinations and made on demand by a customer at the point-of-sale from tire components having reduced shelf times relative to an inventory of unitary tires each having a fixed tread-casing combination.

In another exemplary embodiment, the disclosure describes a system for manufacturing a tire selected having a certain performance and/or size characteristic from a range of tread-casing combinations having a range of performance and/or size characteristics from a reduced inventory supply. The system includes at least one manufacturing facility configured to produce a plurality of different types of cured casings and a plurality of different types of cured treads, wherein certain tire casings are combinable with certain treads to produce finished tires having customizable performance characteristics. The system further includes at least one inventory facility configured to maintain inventories of the different types of casings and treads. Each inventory facility is associated with at least one retail channel. At least one retail facility is associated with the at least one inventory facility and is configured to be a point-of-sale for customized tires that is located at the same location as or near (such as, within about 50 miles, for example) from the corresponding inventory facility. Either the inventory facility or the point-of-sale facility can include manufacturing equipment for assembling a cured casing and a cured tread into a finished new tire having a particular tread-casing combination. In some embodiments, an assembly facility can be interposed between the inventory facility and the point-of-sale facility, and the tread and casing assembly can occur at that facility.

A computer environment can interconnect each manufacturing facility, inventory facility, assembly facility, and point-of-sale facility involved in the system for manufacturing a tire. The computer environment can include a processor and a tire inventory control application stored on a tangible computer-readable medium. The processor is adapted to execute the tire inventory control program contained on the physical computer-readable medium. A graphical user interface can be adapted to input information into the tire inventory control program and receive output information from the tire inventory control program. The tire inventory control program includes computer executable instructions adapted to facilitate the performance of steps for producing a tire having a particular tread-casing combination from a range of tread-casing combinations with a reduced tire inventory and/or for producing a tire having a particular tread-casing combination from an inventory supply having reduced storage time.

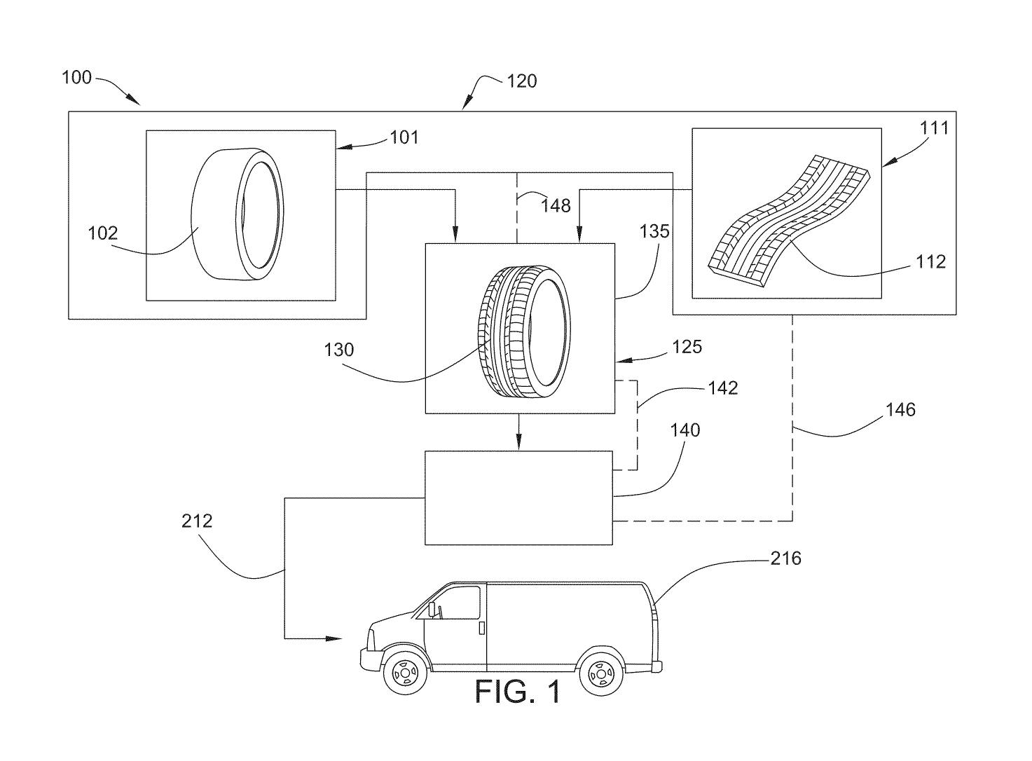

Turning now to the Figures, as shown in FIG. 1, the present disclosure relates to inventory control techniques for a distributed manufacturing system 100 for new tires. The distributed manufacturing system 100 includes an inventory 101 of different types of cured tire casings 102 and an inventory 111 of different types of cured treads 112. The inventories 101, 111 of casings 102 and treads 112 are maintained in an inventory facility 120 and stocked with treads and casings made at an original equipment manufacturer (OEM) casing manufacturing facility and an OEM tread manufacturing facility, respectively. In some embodiments, the casing manufacturing facility can be different than the tread manufacturing facility. In other embodiments, the casing manufacturing facility and the tread manufacturing facility can be a single facility.

Each different type of casing 102 and each different type of tread can be associated with an identifier, such as alphanumeric casing and tread model numbers, for example. Model number, as used herein, is meant to refer to a particular identifier used by the OEM to characterize each type of casing and tread.

Each particular tread and casing can further have associated with it a machine-readable identifier which can include data indicating whether the associated tire component is a casing or a tread, its origin of manufacture, date of manufacture and production lot number, and whether the component is a particular type of casing or style of tread. In embodiments, the information can include a unique product identifier which is unique to that particular component. Each unit of a tread or casing produced can be assigned a unique product identifier, such as a serial number, by which the individual unit can be tracked throughout its life.

The inventories 101, 111 of tire casings 102 and treads 112 are maintained in the inventory facility 120 that is associated with an assembly facility 125 for on-demand delivery to the assembly facility 125 to fill an order for the production of a tire 130. Each inventory 101, 111 of tire casings 102 and treads 112 is stocked with more than one type of casing 102 and more than one type of tread 112, which can be combined to produce more than one model of tire 130 so that a set 135 of tires 130 having a range of tread-casing combinations can be made on demand from the inventories 101, 111.

In some embodiments, the set of tread types can exceed the number of casing types such that the number of possible tread-casing combinations from the array of casing types and tread types is far greater than the sum of the number of tread types and the number of casing types. In this way, the inventories of component parts that can be used to satisfy orders for a given array of tread-casing combinations is reduced relative to an inventory of unitary tires covering the same array of tread-casing combinations.

The assembly facility 125 can include various machines and skilled technicians that can build a new tire using a casing and tread pulled from the inventories 101, 111 of tire casings 102 and treads 112. In the illustrated embodiment, the assembly facility 125 functions in response to orders from a point-of-sale facility 140 that are provided through an order fulfillment communication channel 142 between the point-of-sale facility 140 and the assembly facility 125. The order fulfillment communication channel 142 can provide the assembly facility 125 information about tire orders to be fulfilled, which can include the number of tires to be manufactured as well as the specific model numbers for the casing and the tread that should be used to manufacture each tire. An order notification communication channel 146 between the point-of-sale facility 140 and the inventory facility 120 can be used in a similar fashion to notify the inventory facility 120 that an order for tires with particular tread-casing combination have been made.

When an order for a tire is received at the assembly facility 125 via the order fulfillment communication channel 142, the order can be placed in a queue of pending orders at the assembly facility 125. The order can be analyzed by an inventory control application to determine which model number casing should be pulled from the casing inventory 101 and which model number of tread should be pulled from the tread inventory 111. An inventory supply communication channel 148 between the assembly facility 125 and the inventory facility 120 can be used to allow for communication therebetween to notify the inventory facility what particular casings and treads should be sent to the assembly facility 125. Thereafter, the particular casing and tread are retrieved from their respective inventories 101, 111 either manually by a technician or by use of an automated inventory control system. The inventory facility 120 can use the inventory supply communication channel 148 to notify the assembly facility 125 that a selection of casings and treads from the inventories 101, 111 are being sent to the assembly facility 125.

At the assembly facility 125, the retrieved casing and tread are combined to form a tire preform 210 that is customized to the order. The processes to combine the casing with the tread may include various operations, such as buffing of the base portion of the casing to remove oxidation, deposition of cushion gum on the casing, fitting, pressing and stitching of the tread around the casing, and the like. After the tire has been assembled, it may further undergo a pressing and vulcanization operation to complete the tire 130. A customer 216 can complete a tire transaction 212 with the point-of-sale facility 140 to receive the finished tire 130.

Manufacturing cured casings 102 separate and apart from cured treads 112 can impart advantages particularly related to the performance characteristics of a tire 130 made with a separately manufactured casing 102 and tread 112. In embodiments, one advantage that can be realized by manufacturing tire treads 112 separate and apart from tire casings 102 is that the tire treads 112 can be cured using a temperature profile that is different than that used when the curing that tire tread 112 along with a tire casing 102.

Certain parts of a unitary tire are thinner than other parts of the tire. Curing the tire as a single unit can result in certain areas of the tire being under-cured and certain areas of the tire being over-cured. Over-curing and/or under-curing areas of the tire tread can result in reduced performance characteristics, such as, negatively affecting the rolling resistance of the tire.

When the tread 112 is manufactured separate and apart from the casing 102, the possibility of producing over-cured or under-cured areas of the tire can be reduced. For example, zoned curing, where different parts of the tire component are subjected to different curing temperatures and/or curing time, can be used to cure the casing 102 in a different way than the tread 112 is cured. For example, the exterior of a tread 112 or casing 102 can be cured at a certain temperature while curing the interior of the tread 112 or casing 102 at a different temperature. For example, in embodiments, the exterior surface of the tire tread 112 can be cured at a curing temperature that is lower than the curing temperature to which the interior surface of the tire tread 112 is exposed. It will be appreciated that in different embodiments, different curing profiles can be used for different types and/or sizes of tire treads to produce the desired performance characteristics. Furthermore, in embodiments, the different types of casings can be subjected to curing profiles that are different than the curing profiles used for the types of tread with which they are compatible.

The zoned curing provided by the distributed manufacturing method is an additional advantage to manufacturing tire treads and casings separately, and it can further reduce the possibility of over-curing or under-curing the components. This can help to enhance certain performance characteristics of the tread and the casing when combined to form a new tire, including characteristics such as tire durability, tread life, rolling resistance, snow and ice traction, wet fraction, fuel usage for highway driving, fuel usage for city driving, and cornering ability.

Another advantage to manufacturing the treads and casings separate from each other can include decreasing the curing time. Because the amount of material being cured in each component is less and there is a greater ability to zone cure the tread and the casing, curing time for each component can be reduced in some embodiments. This reduction in curing time can allow a manufacturer to produce more tire treads and tire casings in a given amount of time.

In embodiments of the present disclosure, the tire casings are specially manufactured such that the a circumferential base area of the casing, which is adapted to receive the tread, is a predetermined thickness that is thicker than what is needed to achieve a tire of a given circumference when bonded to a tread. The thickness of the base area is made larger such that the casing can be subjected to a buffing operation to reduce the thickness to accommodate tire treads of differing thicknesses offering customers a greater ability to customize a preferred tire. The thickness of the base layer can be adjusted such that when a particular tread is joined to the casing, the finished new tire is within a range of tolerance of a nominal outer diameter for the specified tire. In some embodiments, the tread can be provided with side flange members that can be trimmed after being joined to the casing to further provide a clean finished appearance at the shoulder area between the sidewalls of the casing and the tread.

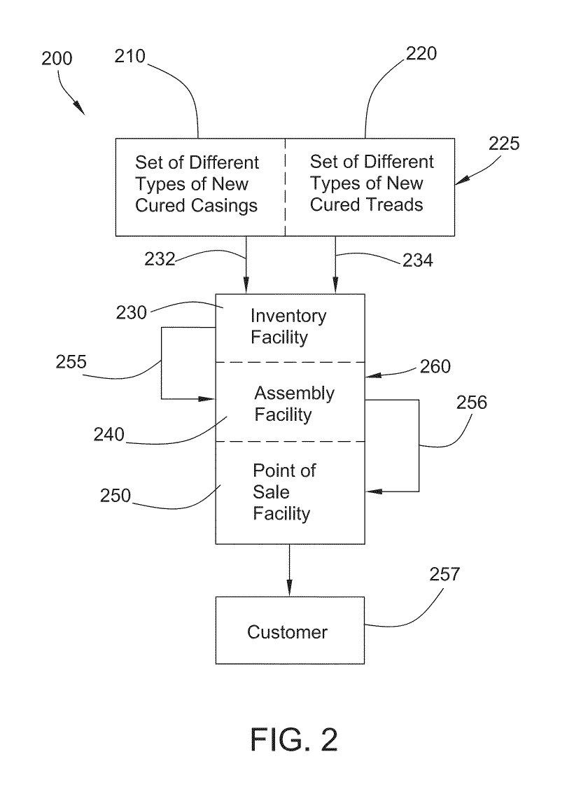

Referring to FIG. 2, an embodiment of an inventory supply system 200 is shown. A casing manufacturing facility 210 and a tread manufacturing facility 220 can comprise a single manufacturing facility 225. The casing manufacturing facility 210 is configured to make a set of different types of cured casings. The tread manufacturing facility 220 is configured to make a set of different types of cured treads. The casings and treads are configured such that certain tire casings are combinable with certain treads to produce finished tires having customizable performance characteristics.

The inventory supply system 200 includes at least one inventory facility 230, which is configured to maintain inventories of the different types of casings and treads. The inventory facility 230 can receive an inventory 101 of casings 102 through a supply channel 232 between the inventory facility 230 and the manufacturing facility 225. Similarly, the inventory facility 230 can receive an inventory 111 of treads 112 through a supply channel 234 between the inventory facility 230 and the manufacturing facility 225. The inventories 101, 111 of casings 102 and treads 112 are maintained in the inventory facility 230.

An assembly facility 240 can be associated with the inventory facility 230 and a point-of-sale facility 250. The inventory facility 230 can supply 255 particular casings 102 and treads 112 to the assembly facility 240 from the inventories 101, 111 maintained in the inventory facility 230 according to an inventory control system. Particular treads 112 and casings 102 can be assembled to form new tires 130 at the assembly facility 240 according to orders generated at the point-of-sale facility 250. Finished new tires 130 can be delivered from the assembly facility 240 to the point-of-sale facility 250 through a tire supply channel 256 for delivery to a customer 257. In the illustrated embodiment, the inventory facility 230, the assembly facility 240, and the point-of-sale facility 250 comprise a single facility 260.

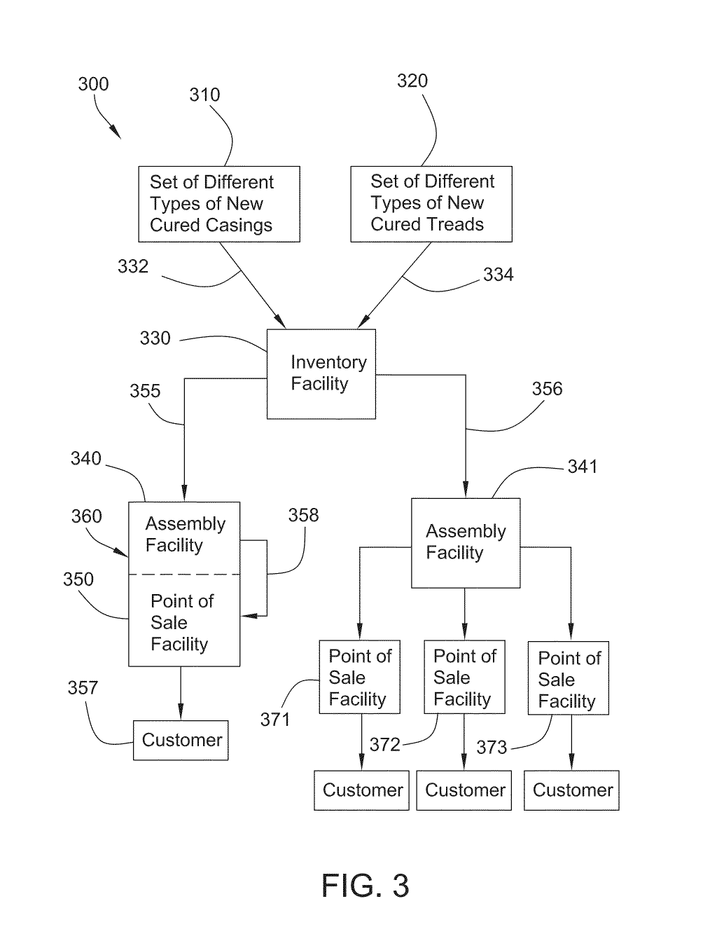

Referring to FIG. 3, another embodiment of an inventory supply system 300 is shown that includes a casing manufacturing facility 310 and a separate tread manufacturing facility 320. The casing manufacturing facility 310 is configured to make a set of different types of cured casings. The tread manufacturing facility 320 is configured to make a set of different types of cured treads. The casings and treads are configured such that certain tire casings are combinable with certain treads to produce finished tires having customizable performance characteristics.

The inventory supply system 300 includes at least one inventory facility 330, which is configured to maintain inventories of the different types of casings and treads. The inventory facility 330 can receive an inventory 101 of casings 102 through a supply channel 332 between the inventory facility 330 and the casing manufacturing facility 310. Similarly, the inventory facility 330 can receive an inventory 111 of treads 112 through a supply channel 334 between the inventory facility 330 and the tread manufacturing facility 320. The inventories 101, 111 of casings 102 and treads 112 are maintained in the inventory facility 330.

First and second assembly facilities 340, 341 are associated with the inventory facility 330. The inventory facility 330 can have first and second supply channels 355, 356 respectively associated with the first and second assembly facilities 340, 341 to deliver particular casings 102 and treads 112 to the assembly facilities 340, 341 from the inventories 101, 111 maintained in the inventory facility 330 according to an inventory control system. Particular treads 112 and casings 102 can be assembled to form new tires 130 at each assembly facility 340, 341 according to tire orders received by the respective assembly facility 340, 341.

The first assembly facility 340 and a first point-of-sale facility 350 comprise a single facility 360. The first point-of-sale facility 350 can have its tire orders fulfilled by the adjoining first assembly facility 340 through a tire supply channel 358 for delivery to a customer 357.

The second assembly facility 341 can fulfill tire orders issued by a number of separate point-of-sale facilities 371, 372, 373. In the illustrated embodiment, the second assembly facility 341 and the point-of-sale facilities 371, 372, 373 to which it supplies tires are separate facilities.

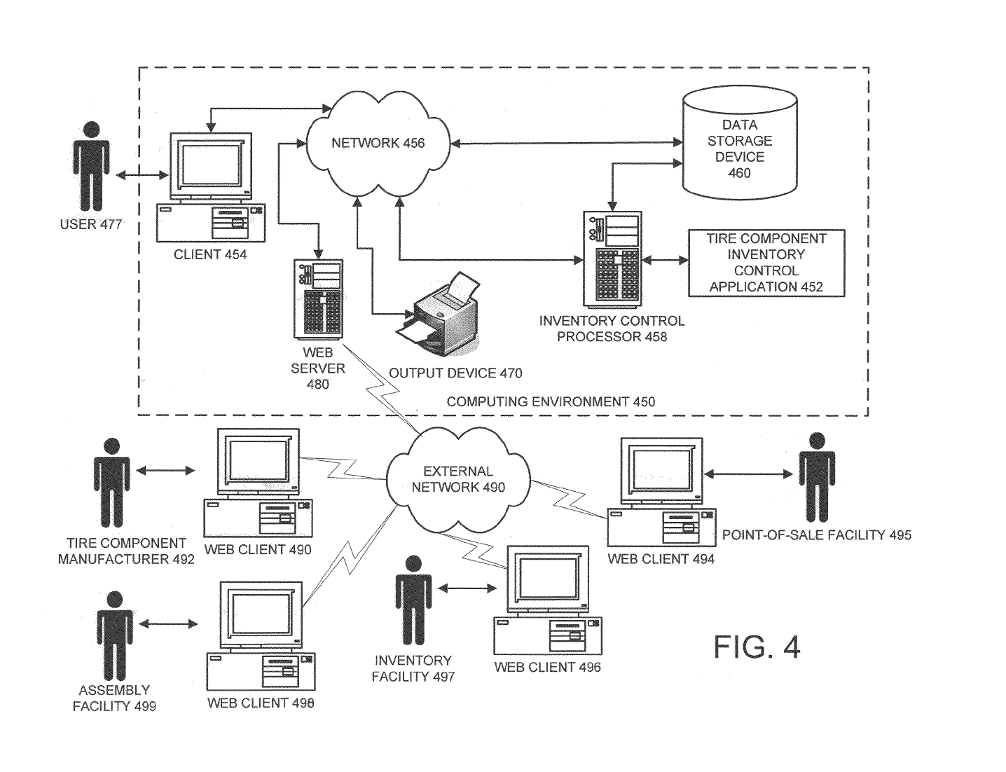

FIG. 4 is an embodiment of a computing environment 450 including a tire component inventory control application 152 for use with a distributed manufacturing system according to principles of the present disclosure. The computing environment 450 can include a number of computer systems, which generally can include any type of computer system based on: a microprocessor, a mainframe computer, a digital signal processor, a portable computing device, a personal organizer, a device controller, or a computational engine within an appliance. More specifically, the computing environment 450 can include a client 454, an internal network 456, at least one inventory control processor 458 operating the inventory control application 452, a data storage device 460, an output device 470, and a web server 480 operatively connected to an external network 490. The client 454, the inventory control processor 458, the data storage device 460, the output device 470, and the web server 480 are operatively connected together via the internal network 430.

A plurality of web clients 490, 494, 496, 498 can use the computing environment 450 to interface with the computing environment 450. For example, a tire component manufacturer 492 can use the web client 490 to receive information from, and to transmit information to, the computing environment 450 about the production and delivery of sets of different types of cured casings and/or cured treads as discussed above. A point-of-sale facility 495 can use the web client 494 to transmit order information from the web client 494 for use by the inventory control application 452, which order information can in turn be communicated to an inventory facility 497 via the web client 496. The inventory facility 497 can use the web client 496 to transmit information to the computing environment 450 about available inventories of cured casings and cured treads, shipping details to inform an associated assembly facility 499 that a shipment of cured casings and/or cured treads has been made to that assembly facility 499, etc. In other embodiments, a different communication channel can be established between the tire component manufacturers, inventory facilities, assembly facilities, point-of-sale facilities, etc. and the inventory control application 452 to transmit tire component, inventory, tire order, and other information to the inventory control application 452.

The client 454 can be used to communicate with an authorized user 77, to enter tire component inventory data into the data storage device 460, and/or to execute the inventory control application 452. The client 454 can comprise at least one input device. The client 454 can generally include any node on a network including computational capability and including a mechanism for communicating across the network 456.

In one embodiment, the client 454 hosts an application front end of the inventory control application 452. The application front end can generally include any component of the inventory control application 452 that can receive input from the user 477 or the client 454, communicate the input to the inventory control application 452, receive output from the inventory control application 452, and present the output to the user 477 or the client 454. In embodiments, the application front end includes a graphical user interface displayed on a connected web client. In embodiments, the application front end can be a stand-alone system.

The network 456 can generally include any type of wired or wireless communication channel capable of coupling together computing nodes. Examples of a suitable network 456 include, but are not limited to, a local area network, a wide area network, or a combination of networks.

The inventory control processor 458 can generally include any computational node including a mechanism for servicing requests from a client for computational resources, data storage resources, or a combination of computational and data storage resources. Furthermore, the inventory control processor 458 can generally include any system that can host the inventory control application 452. The inventory control processor 458 can generally include any component of an application that can receive input from the web clients 490, 494, 496, 498 via the web server 480 or the client 454, process the input, and present the output to the inventory control application 452, the web server 480, and/or the data storage device 460. The inventory control processor 458 can generally include any component of an application that can process data, interact with the data storage device 460, and execute business logic for the inventory control application 452.

The inventory control application 452 comprises a computer program product residing on a computer readable medium having a plurality of instructions stored thereon which, when executed by the inventory control processor 458, cause the inventory control processor 458 to perform steps associated with controlling stores of inventory of sets of different types of cured casings and cured treads for manufacturing a tire selected from a range of tread-casing combinations having a range of performance and/or size characteristics to have a certain performance and/or size characteristic from a reduced inventory supply. Any suitable computer-readable storage medium can be utilized, including, for example, hard drives, floppy disks, CD-ROM drives, tape drives, zip drives, flash drives, optical storage devices, magnetic storage devices, and the like. The client 454 can be used by an authorized user 477 to help administer the inventory control application 452.

The database or data storage device 460 can generally include any type of system for storing data in non-volatile storage. This includes, but is not limited to, systems based upon: magnetic, optical, and magneto-optical storage devices, as well as storage devices based on flash memory and/or battery-backed up memory. In one embodiment, the database 460 contains information associated with the various inventories of different types of casings and treads used in a distributed manufacturing system for producing new tires. This information can be used by the inventory control application 452 to periodically determine the need to order addition components from one of or more of the tire component manufacturers, for example, and to determine which particular units should be used to fulfill orders so that the average age of the inventory is reduced. The data storage device 460 can contain a permission database which stores user credentials and permissions specific to each user 477, tire component manufacturer 492, inventory facility 497, assembly facility 499, and point-of-sale facility 495 associated with the computing environment 450. In some embodiments, access to the computing environment 450 can be granted in at least some capacity to end customers.

The output device 470 can comprise a printer, a display monitor, and a connection to another device, for example. The output device 470 can be used to generate reports for sending to one or more of the user 477, tire component manufacturer 492, inventory facility 497, assembly facility 499, and point-of-sale facility 495. The reports can contain information generated by the inventory control application 452. The output device 470 can be used to communicate to the user 477 information about the inventories of cured casings, cured treads, and other materials used to build a tire using a distributed manufacturing system according to principles of the present disclosure, which is generated by the inventory control application 452.

A report engine can be provided to generate displays of information stored in the data storage device 460 concerning the inventories of cured casings, cured treads, and other materials used to build a tire using a distributed manufacturing system according to principles of the present disclosure, which can be viewed using the output device 470, for example. In one embodiment, the report engine further provides pre-configured and/or ad hoc reports relating to the inventories of cured casings, cured treads, and other materials used to build a tire using a distributed manufacturing system according to principles of the present disclosure.

The web server 480 can provide a suitable web site or other Internet-based graphical user interface which is accessible by each tire component manufacturer 492, inventory facility 497, assembly facility 499, and point-of-sale facility 495 associated with the computing environment 450, for example. The web clients 490, 494, 496, 498 can be connected to the web server 480 through the network connection 490 (e.g., Internet, Intranet, LAN, WAN and the like). The web server 480 can use an authentication server in order to validate and assign proper permissions to authorized users of the system. A permission database can store web user credentials and permissions specific to each user 477, tire component manufacturer 492, inventory facility 497, assembly facility 499, point-of-sale facility 495, etc., associated with the computing environment 450. The web server 480 can be outfitted with a firewall such that requests originating from outside the computing environment pass through the firewall before being received and processed at the web server 480.

In addition to the components discussed above, the computing environment 450 can further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

In use, the manufacturing process for a customized tire begins when an order for a tire is placed at a point-of-sale facility or is otherwise provided to the inventory control application 452, for example, through the Internet. A customer can visit a point-of-sale facility and select t least one of a tire having at least one selected tire characteristic, such as performance and/or size characteristics under various parameters that are best suited for the customer's particular needs, and a specific casing-tread combination to provide such a tire. Such tire characteristics may be, for example, the tire's outer diameter, rolling resistance, wear resistance, traction capability under different weather and climate conditions, speed rating, drive-surface-specific features, and others.

After the customer has selected the desired number and type of tires to be purchased, the sales associate can enter the customer's order into an automated ordering system installed at the point-of-sale facility, which is in communication with the inventory control application 452. The automated ordering system can include a computer system having a processor and tangible storage media having stored thereon computer executable instructions, which are accessible by the processor and at least partially modifiable or configurable by user input and output devices, such as computer terminals. Accordingly, the sales associate can enter the customer's order into the ordering system by providing sufficient order information that can include the type, model number and number of tires ordered by the customer as well as other information such as billing or payment information, time and place of delivery of the tires, whether the customer wishes to have the tires installed into a vehicle at the point-of-sale facility, and other information.

Information relative to the tires ordered by the customer can be sent from the ordering system to inventory control application 452. The inventory control application 452 is adapted to receive the order information from the point-of-sale facility, and parse that information into an identification of the number and model number of the cured casing type and cured tread type that are used to build the ordered tire or tires. The inventory control application 452 can send this information to the inventory facility and/or assembly facility associated with the point-of-sale facility placing the order. With this information in hand the inventory facility and the assembly facility can take steps to retrieve the designated components from inventory and make them available to the assembly facility so the tire order can be fulfilled.

In embodiments, the inventory control application 452 is adapted to carry out additional functionality and tracking such as tracking the amount of inventory of each type of tread and casing in the inventory facility such that additional replacement components can be ordered from the appropriate tire component manufacturer when the inventory of a particular type of tread and/or casing is reduced to a selected threshold level, for example, prioritization of tire building and finishing based on the timing information of each order, and so forth. The tire inventory control program 452 can be adapted to track the amount of each type of cured tread in the tread inventory and the amount of each type of cured casing in the casing inventory, and, in response to a particular type of cured tread or cured casing falling below a particular threshold, generate a notification indicating such condition.

When the particular pull-information for casings and treads from the respective inventories of tire casings and 203 has been compiled, the inventory control application 452 can generate an inventory order signal that is sent to the inventory facility so the particular components can be taken from inventory and provided to the assembly facility. In some embodiments, the inventory order signal can specify particular units of the type of tread and casing used to fulfill the order according to unique identifiers provided by machine-readable identifiers attached to each component in inventory.

For example, in some embodiments, the inventory control application 452 can be adapted to follow a first-in, first-out procedure whereby the particular component of a given type that enters inventory first in time is used before other components of the same type that entered inventory later in time. The inventory control application 452 can track how much time has elapsed since the particular component has been produced and designate a priority rank for the components according to the age of the components such that older components are used before newer components of the same type to fulfill orders using those components.

In other embodiments, the inventory control application 452 can divide each unit in inventory of a given type of tire component into one of a number of time period ranges. When an order is received for a tire, the inventory control application 452 can generate an inventory order signal that indicates that any unit in a particular age range can be used to fulfill the order. As an example, the units in inventory for a given tread type can be split into one of two time periods determined by splitting the time range between the newest unit and the oldest unit in half to form a “new” time period and an “old” time period. When an order is received for a tire that uses that type of tread, the inventory control application 452 can generate an order signal that indicates that any tread of the type in the old time period can be used to fulfill the order. The inventory control application 452 can identify which units fall into the old time period using any suitable technique, such as by location in the inventory facility, batch number, serial number, unique identifier, etc.

The customization of the tire, as previously discussed, can include a set of choices for the customer based upon at least one of various performance attributes of the chosen tread-casing combination. Once a choice has been made, the inventory control application 452 can determine whether parts are available at the inventory facility to build the selected tire. In the event a particular casing and tread combination is not currently available, for example, in existing inventory, the system can prompt the customer with an alternative selection that uses available parts and has performance characteristics that are equivalent or close to those originally selected by the customer at and/or further inform the customer of an expected lead time for that point-of-sale facility to obtain a tire with the necessary components to build the customer's original selection. In other embodiments, the system can perform a query of other associated inventory facilities to find the nearest point-of-sale facility within a specified range of the point-of-sale facility in question, that can fulfill the customer's original selection using in-stock tire components from its associated inventory facility.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for manufacturing tires having a predetermined tire characteristic, said system comprising:
an inventory facility configured to maintain a casing inventory including a plurality of different types of cured casings and a tread inventory including a plurality of different types of cured treads;
an assembly facility including tire building equipment adapted to produce a new tire having the predetermined tire characteristic using a tread-casing combination including a selected type of the cured casings in the casing inventory and a selected type of the cured treads in the tread inventory of the inventory facility;
wherein the casing inventory and the tread inventory are configured such that, for a particular type of cured casing in the casing inventory, multiple types of cured treads in the tread inventory are compatible with the particular type of cured casing to produce different tread-casing combinations, each including said particular type of cured casing.

2. The system for manufacturing tires of claim 1, wherein a set of tread-casing combinations from the casing inventory and the tread inventory of the inventory facility are adapted to produce the new tire having the predetermined tire characteristic.

3. The system for manufacturing tires of claim 1, wherein the number of different types of cured treads in the tread inventory is larger than the number of different types of cured casing in the casing inventory.

4. The system for manufacturing tires of claim 1, wherein the inventory facility and the assembly facility comprise a single facility.

5. The system for manufacturing tires of claim 1, further comprising:
a computer system adapted to interconnect the inventory facility and the assembly facility, the computer system including a processor specially programmed with a tire inventory control program stored on a tangible computer-readable medium.

6. The system for manufacturing tires of claim 5, wherein the computer system is specially programmed to include an inventory supply communication channel between the assembly facility and the inventory facility, the inventory supply communication channel adapted to indicate to the inventory facility the particular types of cured casings and cured treads in the respective casing inventory and the tread inventory designated for transfer to the assembly facility in response to receiving a tire order.

7. The system for manufacturing tires of claim 6, further comprising:
a point-of-sale facility interconnected with the inventory facility and the assembly facility through the computer system;
wherein the computer system is specially programmed to include an order fulfillment communication channel between the point-of-sale facility and the assembly facility, the order fulfillment communication channel adapted to provide the assembly facility with tire order information relating to tire orders to be fulfilled by the assembly facility.

8. The system for manufacturing tires of claim 7, wherein the computer system is specially programmed to use the tire order information to determine at least one suitable tread-casing combination from the tread inventory and the casing inventory of the inventory facility to produce a new tire to fulfill the tire order.

9. The system for manufacturing tires of claim 7, wherein the assembly facility and the point-of-sale facility comprise a single facility.

10. The system for manufacturing tires of claim 7, wherein the inventory facility, the assembly facility, and the point-of-sale facility comprise a single facility.

11. A method of manufacturing tires having a predetermined tire characteristic, said method comprising:
maintaining at an inventory facility a casing inventory including a plurality of different types of cured casings and a tread inventory including a plurality of different types of cured treads, the cured treads being separately manufactured from the cured casings;
in response to receiving a tire order for a tire having a particular tire characteristic, building a new tire using a tread-casing combination including a selected type of the cured casings in the casing inventory and a selected type of the cured treads in the tread inventory of the inventory facility, the new tire having the tire characteristic;
wherein the casing inventory and the tire inventory are configured such that, for a particular type of cured casing in the casing inventory, multiple types of cured treads in the tread inventory are compatible with the particular type of cured casing to produce different tread-casing combinations including said particular type of cured casing.

12. The method of manufacturing tires of claim 11, wherein the new tire is built using a particular cured casing of the selected type, said particular cured casing selected from a group of casings of said casing type that has an average age that is greater than the average age of the remainder of the inventory of said type of cured casing, and the new tire is built using a particular cured tread of the selected type, said particular cured tread selected from a group of treads of said tread type that has an average age that is greater than the average age of the remainder of the inventory of said type of cured tread.

13. The method of manufacturing tires of claim 11, wherein a range of tread-casing combinations from the casing inventory and the tread inventory of the inventory facility are adapted to produce the new tire having the predetermined tire characteristic.

14. The method of manufacturing tires of claim 11, wherein the number of different types of cured treads in the tread inventory is larger than the number of different types of cured casing in the casing inventory.

15. A tire component inventory control system comprising:
a tire inventory control program stored on a tangible computer-readable medium;
a processor adapted to execute the tire inventory control program contained on the computer-readable medium;
a data storage device operably arranged with the processor and adapted to store therein inventory information relating to a casing inventory including a plurality of different types of cured casings and a tread inventory including a plurality of different types of cured treads maintained at an inventory facility, the cured treads being separately manufactured from the cured casings;
wherein the tire inventory control program is adapted, in response to receiving tire order information identifying a tire having a tire characteristic, to use the tire order information to determine at least one tread-casing combination including a selected type of the cured casings in the casing inventory and a selected type of the cured treads in the tread inventory of the inventory facility, said tread-casing combination adapted to produce the new tire having the tire characteristic.

16. The tire component inventory control system of claim 15, wherein the tire inventory control program is further adapted to track the amount of each type of cured tread in the tread inventory and the amount of each type of cured casing in the casing inventory and, in response to a particular type of cured tread or cured casing falling below a particular threshold, to generate a notification indicating such condition.

17. The tire component inventory control system of claim 15, wherein the tire inventory control program is further adapted to specify particular units of the type of tread and the type of casing used to fulfill the tire order according to unique identifiers provided by machine-readable identifiers attached to each cured casing in the casing inventory and to each cured tread in the tread inventory.

18. The tire component inventory control system of claim 17, wherein the tire inventory control program is further adapted to specify the particular units following a first-in, first-out procedure.

19. The tire component inventory control system of claim 18, wherein the tire inventory control program is further adapted to divide each unit in the casing inventory of a given type into one of a number of time period ranges and to divide each unit in the tread inventory of a given type into one of a number of time period ranges and, in response to receiving the tire order information, generating an inventory order signal for a selected tread-casing combination that any unit in the oldest particular time period range of the casing inventory and in the tread inventory can be used to fulfill the order.

20. The tire component inventory control system of claim 15, wherein the tire inventory control program is further adapted, in the event a particular tread-casing combination is not currently available from the casing inventory and/or the tread inventory, to determine an alternate tread-casing combination that includes a cured tread available in the tread inventory and a cured casing available in the casing inventory and that is adapted to produce a new tire having a tire characteristic that is equivalent or close to the tire characteristic indicated in the tire order information.
